(19) United States
(12) Patent Application Publication
(10) Pub. No.: US 2010/0162765 A1
(43) Pub. Date: Jul. 1, 2010

(54) Atmosphere Regulator and Coating Apparatus for Coating on Float Glass Production Line

(75) Inventors: JIANXUN WANG, Hangzhou (CN); QIYING LIU, Hangzhou (CN); JUNBO LIU, Hangzhou (CN); FANHUA KONG, Hangzhou (CN); HAO YING, Hangzhou (CN); DINGQUAN WANG, Hangzhou (CN); YANFEI SHI, Hangzhou (CN); YIMING YING, Hangzhou (CN); GAORONG HAN, Hangzhou (CN)

Correspondence Address: GLOBAL IP SERVICES, 7285 W. Eagle Court, Winton, CA, 95388, US

(73) Assignee: Hangzhou Bluestar New Materials Technology Co. Ltd., Hangzhou (CN)

(21) Appl. No.: 12/647,284

(22) Filed: Dec. 24, 2009

(30) Foreign Application Priority Data
Dec. 25, 2008 (CN) 200810164118.2

(51) Int. Cl. C03B 37/014

(52) U.S. Cl. 65/157

(57) ABSTRACT

An atmosphere regulator for coating and a coating apparatus on float glass production line are disclosed. Said atmosphere regulator for coating disposed between the district of lift out rolls and the A district of annealing lehr comprises a housing where a plurality of conveyor rolls which transfer sheet glass from said district of lift out rolls to the A district of said annealing lehr are installed, a curtain, an up-turning door and down-turning door are disposed at the joint where said district of lift out rolls and A district of annealing lehr connects. Said coating apparatus comprises a plurality of parallel base boards having a slot in between of the length corresponding to the width of said sheet glass and communicated with the entrance and the exhausting chamber. The present invention has effectively solved the drawbacks occurred in prior arts such as single function for coating, limited adjusting range of film thickness and bad film quality. The present invention is characterized as simple in structure, completeness in function, wide range in film thickness adjustment, good film quality and significant in economic benefit.

### CROSS REFERENCE TO RELATED PATENT APPLICATION

The present application claims the priority of the Chinese patent application No. 200810164118.2 filed on Dec. 25, 2008, which application is incorporated herein by reference.

### FIELD OF THE INVENTION

The present invention relates to an apparatus for large dimensional coated glass with oxide film manufactured on float glass production line, comprising a coating atmosphere regulator and coating apparatus disposed in A0 district of annealing lehr on float glass production line.

### BACKGROUND OF THE INVENTION

The present invention is to modify the surface property of high temperature, speedy drawn and clean float glass by utilizing metal organic chemical vapor deposition (MOVCD) coating technology in annealing lehr to produce series of oxidizing coated glass with varieties of functions such as Low-E coated glass having heat insulation function, solar control TiO2 coated glass having easy cleaning function and electrical conductive coated glass for solar cell.

It is necessary to have a suitable coating apparatus and coating atmosphere for coating on float glass production line. It has been proposed that the structure parameters for coating apparatus must be stable, the number for coating reactant district and the film thickness must be adjustable, moreover, the apparatus must be easy to operate and facilitate, and the coating atmosphere must have an even field of temperature, pressure and flow rate.

However, the coating apparatus for float glass as used in prior arts have some drawbacks, some of them are single function which is only for relatively thinner solar control coated glass, some of them can not have a wide range adjustment for the film thickness to meet the coating requirements of large flow of reactant gas, the function and the quality of the product are badly restricted. Furthermore, coating apparatuses on float glass production line are seldom equipped with atmosphere regulating apparatus to meet the requirements for coating, therefore, in A0 district of annealing lehr on float glass production line, an additional district used for coating disposed between the district of lift out rolls and A district of annealing lehr, there generally occurred some problems such as turbulent airflow, unstable lehr pressure, hard controlled temperature and difficultly operated apparatus, the quality of coating on float glass production line is badly affected, and the process for coating to be applied on float glass production line is hard to control. A coating method for sheet glass substrate and the equipment as the same is disclosed by CN1899998 on Jan. 24, 2007, in which the method and the equipment is applied to be disposed at the exit of tin bath on float glass production line for producing liquid state or solid state coated glass, particularly for solar control coated glass which contains the metal oxide. The invention provides an additional atmosphere control chamber disposed at the exit of the tin bath in coating district, and the coating apparatus, exhausting device are arranged in said control chamber. The atmosphere control chamber which is independent and do not communicate with said tin bath is substantially filled with oxidizing gas of stable pressure. As there is no airflow regulator being used, the temperature is hard to be stable. In addition, a continuous supply of said oxidizing gas to the control chamber not only causes an increase in cost but also the bad influence to the quality of coating by impact from the gas supply to the airflow of coating.

### SUMMARY OF THE INVENTION

The present invention is to solve the problems mentioned above in prior arts as air turbulent, unstable lehr pressure, hard controlled temperature in A0 district of annealing lehr on float glass production line and hard operated apparatus and to provide an coating apparatus which meet the atmosphere requirements of coating process to improve the quality of the product.

Another object of the present invention is to provide a coating apparatus with multi-functional coating, wide range adjustment of thickness and good film quality.

The present invention is described as follows to achieve the object mentioned above: an atmosphere regulator for coating on float glass production line, comprising: a housing, of which the front end connected with the district of lift out rolls, the back end connected with A district of annealing lehr on float glass production line; a plurality of conveyor rolls installed in said housing to transfer the sheet glass from the district of said lift out rolls to A district of said annealing lehr; a first curtain and a first up-turning door are disposed at the joint of said housing and said district of lift out rolls, a first down-turning door is hinged to the cross section of said housing under said rolls, a second curtain and a second up-turning door are disposed at the joint of said housing and A district of said annealing lehr, a second down-turning door is hinged to the cross section under said rolls; a heater is disposed over the sheet glass inside said housing, a plurality of observation windows are formed on the side wall of said housing; a temperature monitor and an air pressure regulator including airflow damper are supportably provided on the top of said housing and communicate therewith, the infrared probe of said temperature monitor aims at the sheet glass, an opening is disposed on the top of said housing for placement of coating apparatus on float glass production line. An additional A0 district of annealing lehr is disposed between the district of lift out rolls and A district of annealing lehr used for coating on float glass production line, the coating atmosphere is adjustable. Curtains and up-turning or down-turning door are disposed on both ends of said housing to adjust the direction and the strength of airflow of the atmosphere by changing the distance to the sheet glass and the turning angle of the door to achieve a stable airflow field of the coating district; the temperature monitor and heater are used to achieve an even and suitable temperature field of the coating district; the pressure regulator is used to achieve a stable pressure field of the coating district to protect the gases which come from the coating apparatus from the influence of outside environment. In use, the coating apparatus is placed in the top opening of said housing, the heater is powered and actuated in accordance to the feedback of the temperature from said temperature monitor to compensate the temperature inside the housing so that the sheet glass and the atmosphere temperature is adapted for coating; adjustment to the distance between front or back curtain and the sheet glass, the turning angle of two up-turning door or two down-turning door are made to control the upper or lower outside airflow established in the district of lift out rolls and A district of annealing lehr so that to maintain the airflow stable inside the housing.

As a preferred embodiment, the housing is composed of sequentially connected square tube of multilayer wall which is filled with heat insulation cotton, and expansion joint formed between adjacent square tube and heat insulation cotton is also filled therein.

As a preferred embodiment, the first up-turning door and the second up-turning door comprise bracket and thereto hinged turnover plate which is covered with stainless steel and filled with heat insulation cotton; said bracket which is made up of square tube of stainless steel is configured to have water inlet and outlet connected with water cooling system. The up-turning door is used to regulate the direction of outside airflow so as the unstable airflow which is over the sheet glass on float glass production line can be directed to outside of the housing to maintain a stable airflow inside the coating district of the housing. While the circulation of cooling water around the bracket of said up-turning door can keep the structure thereof out of deformation.

As a preferred embodiment, the first and the second down-turning door have cavities inside the doorplate and filled with heat insulation cotton thereof. The down-turning door is also used to regulate the direction of outside airflow so as the unstable airflow which is under the sheet glass on float glass production line can be blocked outside of the housing to maintain a stable airflow inside the coating district of the housing. Aluminum silicate is generally used as heat insulation material to keep the structure of the down-turning door undeformed under high temperature as the temperature under the conveyor rolls is lower than that over the glass conveyor.

As a preferred embodiment, the temperature monitor and the pressure regulator are disposed on the top of the housing in A0 district of annealing lehr. The temperature monitor is used to monitor and adjust the temperature of the coating district.

As a preferred embodiment, the heater is disposed over the sheet glass and the temperature monitor has an infrared probe on the top of the housing.

As a preferred embodiment, the opening on the top of the housing has a cover plate.

A coating apparatus on float glass production line, which is disposed on the housing top of the atmosphere regulator, comprises a plurality of parallel base boards with slot in between configured to have length corresponding to the width of the sheet glass and communicated with alternately disposed entrance chamber and exhausting chamber thereover, the exit of the entrance chamber and the entrance of the exhausting chamber corresponding to the slot formed in between of the base board having cooling cavity filled with heat transfer oil as cooling media thereover. Graphite block with round side in structure is disposed under the base board. Entrance lane and exhausting lane with the width of the slot are formed between said adjacent graphite block, the air entrance of the entrance chamber communicate with air entrance distributor which connects to the air entrance duct, the air exit of the exhausting chamber communicate with air exhaustion collector which connects to the air exhausting duct. Each entrance chamber and exhausting chamber are independent in the coating apparatus, therefore it can be assembled or dismantled freely to meet the production requirements so as to establish a plurality of parallel entrances and exhaustion stable airflow to improve the quality of coated glass. The width of air entrance lane and air exhausting lane is easily to be adjusted by changing the slot width of the base board. The air inflow and outflow in each of the entrance and exhausting chamber are adjustable so as to have a wide range of thickness adjustment to produce coated glass with various film thickness and batch production of good quality Low-E coated glass.

As a preferred embodiment, the entrance chamber of the coating apparatus is cone-shape in structure having air distributor disposed at the air exit to uniformly distribute the airflow and air damper disposed inside thereof. The air distributor uniformly distributes the airflow to maintain a uniform film on the surface of coated glass. The air entrance chamber and the air distributor, air damper all are used to have an even flowing and uniform distribution of the working gas.

As a preferred embodiment, the air damper and negative pressure regulator are disposed inside the exhausting chamber and the air damper is at the end of the air entrance. The coating quality is secured only by a stable inflow and outflow of air.

As a preferred embodiment, the width of the slot of the coating apparatus which is communicated with the exhausting chamber is wider than that which is communicated with the entrance chamber.

Usually 2 to 8 entrance chambers and 3 to 9 exhausting chambers are disposed in the coating apparatus, the exhausting chamber is one more than the entrance chamber, and adjacent entrance chamber and exhausting chamber have the same spacing. The entrance and the exhausting chamber are used to control the flow rate of working gas and exhaustion so as to achieve required thickness and uniformity of the film on coated glass.

The beneficial effect of present invention is that it effectively solved the drawbacks occurred in prior art such as single function for coating, the adjusting range of film thickness is limited and bad film quality. The present invention is characterized as simple in structure, completeness in function, wide range in film thickness adjustment, good film quality and significant in economic benefit.

### BRIEF DESCRIPTION OF THE DRAWINGS

FIG. 1 is a structural view showing an embodiment of atmosphere regulator for coating on float glass production line;

FIG. 2 is a structural view of the cross section showing an embodiment of atmosphere regulator for coating on float glass production line;

FIG. 3 is a structural view showing an embodiment for coating apparatus on float glass production line;

FIG. 4 is an A-A structural view of FIG. 3;

FIG. 5 is a structural view showing an embodiment of an up-turning door of the atmosphere regulator for coating on float glass production line.

### DETAILED DESCRIPTION OF THE PREFERRED EMBODIMENT

The present invention will be further described by the following preferred embodiment in conjunction with the drawings thereof.

### Example 1

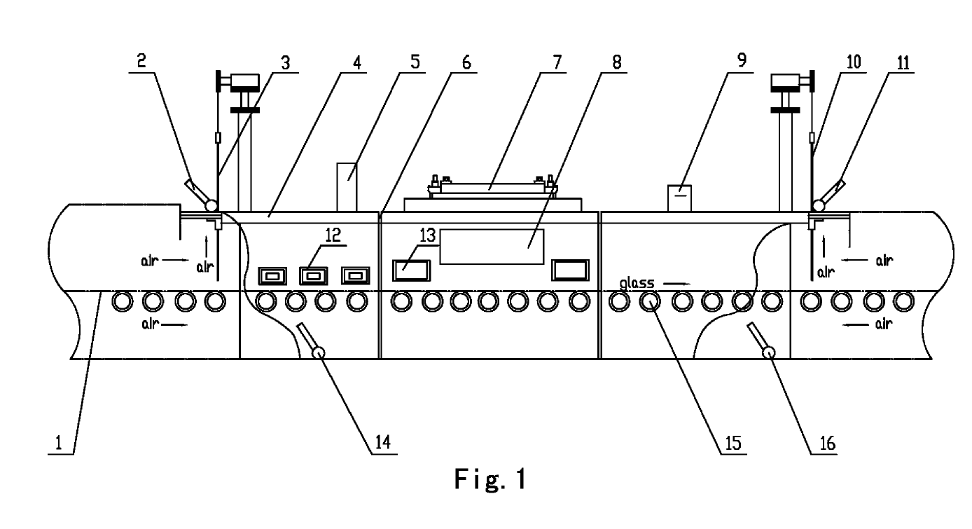

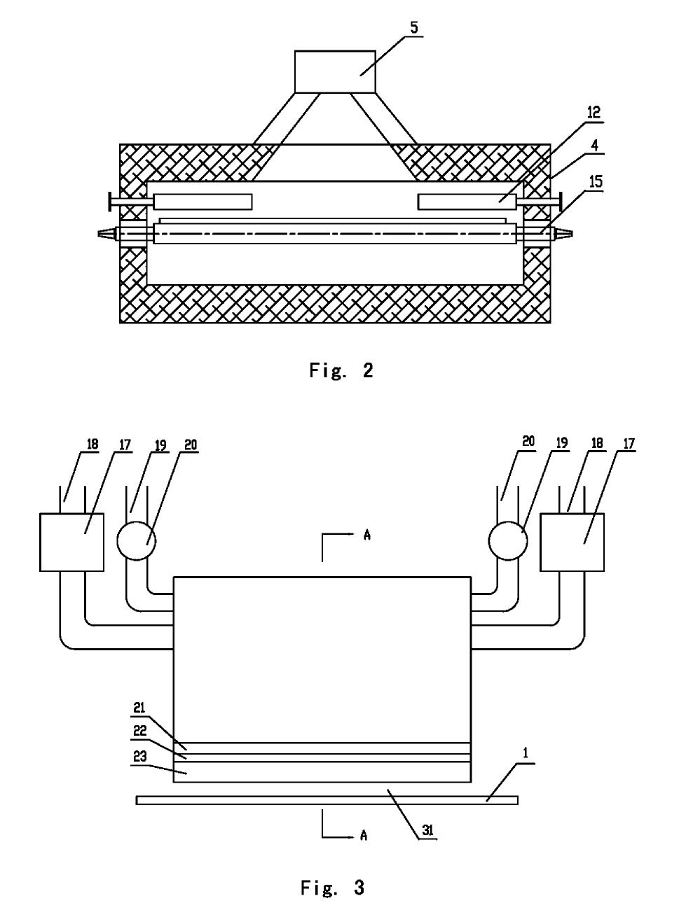

As shown in FIG. 1 and FIG. 2 of this example, an atmosphere regulator for coating on float glass production line, comprises a set of atmosphere regulator of coating disposed in A0 district and coating apparatus disposed therein, said A0 district is connected with the district of lift out rolls by its front end and A district of annealing lehr by back end, said a set of atmosphere regulator of coating disposed in A0 district comprises housing 4 which is sequentially connected square tube of multilayer wall filled with heat insulation material, joint 6 is formed in between adjacent tubes and heat insulation material is filled therein. Conveyor rolls 15 are installed in the housing to drive the sheet glass 1 from the district of lift out rolls to A district of annealing lehr, the first curtain 3 and the first up-turning door 2 are disposed over the conveyor rolls of the joint where the district of lift out rolls is connected to the housing and the first down-turning door 14 is disposed under the conveyor rolls, the second curtain 10 and the second up-turning door 11 are disposed over the conveyor rolls of the joint where the A district of annealing lehr is connected to the housing and the second down-turning door 16 is disposed under the conveyor rolls. The first up-turning door and the second up-turning door comprise bracket 33 and thereto hinged turnover plate 32 (FIG. 5) which is covered with stainless steel and filled with heat insulation cotton; said bracket which is made of square tube of stainless steel is configured to have water inlet and outlet which connects with water cooling system.

The heater 12 is disposed over the sheet glass inside the housing which has observation windows 13 on the side wall thereof; the temperature monitor 5 and the pressure regulator 9 including airflow dampers are supportably provided on the top of and communicated with the housing. The housing further has an opening formed on the top thereof is used for placement of the coating apparatus 8 and a cover plate 7 is disposed thereon.

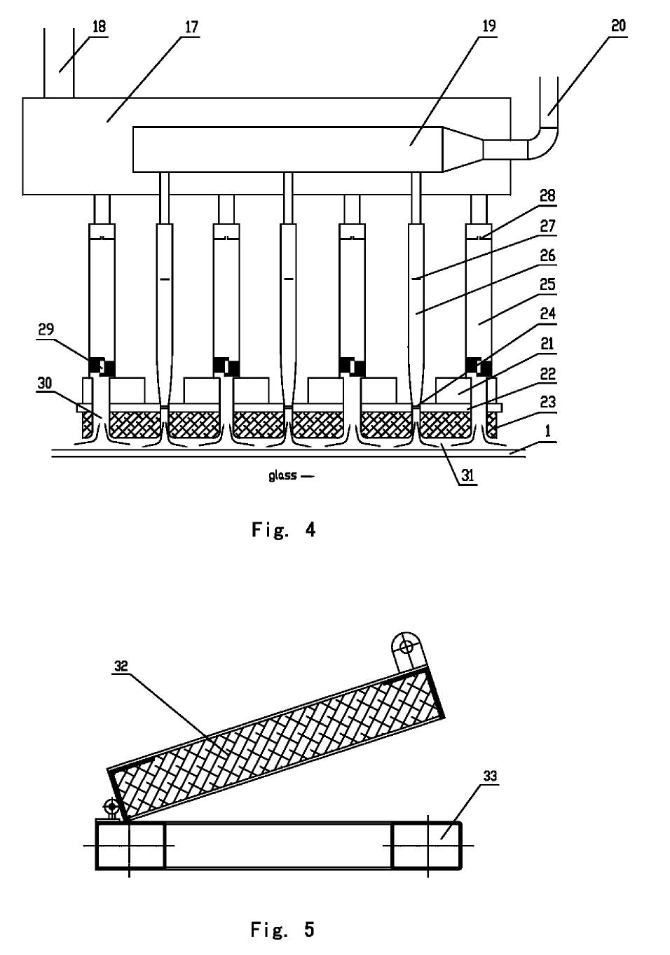

The coating apparatus on float glass production line (referring to FIG. 3 and FIG. 4) which is placed into the housing where the atmosphere regulator for coating is disposed from the opening on the top thereof comprises a plurality of parallel base boards 22 with slot formed in between of length corresponding to the width of sheet glass and communicating with three entrance chamber 26 and four exhausting chamber 25 respectively, the slot width which communicated with the exhausting chamber is wider than that which communicated with the entrance chamber. The entrance chamber is cone-shape in structure having air distributor 24 disposed at the air exit and air damper 27 disposed inside thereof, the air damper 29 and negative pressure regulator 28 are disposed inside the exhausting chamber and the air damper is at the end of the air entrance.

The entrance chamber and the exhausting chamber are alternatively disposed with an equal spacing between adjacent group of entrance chamber and exhausting chamber. The exit of the entrance chamber and the entrance of the exhausting chamber correspond to the slot formed in between of the base board, the width of the slot of the coating apparatus which is communicated with the exhausting chamber is wider than that which is communicated with the entrance chamber. Over the base board there disposed cooling cavity 21 which is filled with heat transfer oil as cooling media and under the base board there disposed graphite block 23 with round side in structure. Entrance lane and exhausting lane with the width of the slot are formed between said adjacent graphite block and there existed a gap 31 between the graphite block and the sheet glass, the air entrance of the entrance chamber communicate with air entrance distributor 19 which connects to the air entrance duct 20, the air exit of the exhausting chamber communicate with air exhaustion collector 17 which connects to the air exhausting duct 18.

### Example 2

Alternatively disposed 2 entrance chamber and 3 exhausting chamber are used in the example 2, any other configurations are the same with example 1.

### Example 3

Alternatively disposed 4 entrance chamber and 5 exhausting chamber are used in the example 3, any other configurations are the same with example 1.

### Example 4

Alternatively disposed 5 entrance chamber and 6 exhausting chamber are used in the example 4, any other configurations are the same with example 1.

### Example 5

Alternatively disposed 6 entrance chamber and 7 exhausting chamber are used in the example 5, any other configurations are the same with example 1.

### Example 6

Alternatively disposed 7 entrance chamber and 8 exhausting chamber are used in the example 6, any other configurations are the same with example 1.

### Example 7

Alternatively disposed 8 entrance chamber and 9 exhausting chamber are used in the example 7, any other configurations are the same with example 1.

When complete equipment for production line of Low-E coated glass with float glass processing is in use, the cover plate is removed with a lift by the hanging point thereof and the coating apparatus is placed into the housing from the opening on the top thereof, the graphite blocks at the bottom of the coating apparatus approach the sheet glass and the heater is actuated according to the temperature feedback from the temperature monitor and the temperature of coating district and the sheet glass are automatically adjusted to meet the requirement of coating processing. The adjustment to the distance between curtain and the sheet glass and to the turning angle of up-turning door and down-turning door can effectively control the outside airflow established at upper side and lower side of the district of lift out rolls and A district of annealing lehr to maintain a stable airflow inside the housing of the coating district. The pressure regulator is to keep the pressure inside the housing stable and to keep the field of temperature, airflow and pressure inside the housing in the coating district evenly distributed. When all the things such as the height of the coating apparatus and other associated conditions which can be observed through the observation windows are going well, the reactant gases are feed into the coating apparatus through the entrance duct of the coating apparatus to have the hot sheet glass being coated continuously, and the offgas are exhausted from the exhausting chamber.

What is claimed is:

1. An atmosphere regulator for coating on float glass production line comprising:
a housing (4), of which a front end connecting with a district of lift out rolls, a back end connecting with A district of annealing lehr on a float glass production line;
a plurality of conveyor rolls (15) installed in said housing to transfer sheet glass (1) from the district of lift out rolls to the district of annealing lehr;
a first curtain (3) and a first up-turning door (2) being disposed at a joint of said housing and said district of lift out rolls, a first down-turning door (14) being hinged to a cross section of said housing under said conveyor rolls (15), a second curtain (10) and a second up-turning door (11) being disposed at the joint of said housing and A district of said annealing lehr, a second down-turning door is hinged to the cross section under said rolls (15);
a heater (12) disposed over a sheet glass inside said housing, a plurality of observation windows (13) being formed on a side wall of said housing;
a temperature monitor (5) and an air pressure regulator (8) including airflow damper being supportably provided on a top of said housing and communicating with the housing, a infrared probe of said temperature monitor (5) aiming at the sheet glass (1), an opening being disposed on top of said housing for the placement of coating apparatus on the float glass production line.

2. An atmosphere regulator for coating on float glass production line as claimed in claim 1, wherein the housing is made up of sequentially connected square tubes with multilayer walls in which is filled with heat insulation cotton, and expansion joint (6) is formed between adjacent square tubes and heat insulation cotton is also filled therein.

3. An atmosphere regulator for coating on float glass production line as claimed in claim 1, wherein said first up-turning door (2) and second up-turning door (11) comprise: a bracket (33) which is made up of square tube of stainless steel and is configured to have water inlet and outlet connected with water cooling system, and a thereto hinged turnover plate (32) which is covered with stainless steel and is filled with heat insulation cotton.

4. An atmosphere regulator for coating on float glass production line as claimed in claim 1, wherein the first down-turning door (14) and the second down-turning door (16) have cavities inside the door plate and filled with heat insulation cotton thereof.

5. An atmosphere regulator for coating on float glass production line as claimed in claim 1, wherein the temperature monitor and the pressure regulator are supportably provided on the top of said housing in A0 district of the annealing Lehr.

6. An atmosphere regulator for coating on float glass production line as claimed in claim 1, wherein the heater is disposed over the sheet glass and the temperature monitor has an infrared probe on the top of the housing.

7. An atmosphere regulator for coating on float glass production line as claimed in claim 1, wherein the opening formed on the top of the housing has a cover plate.

8. A coating apparatus on float glass production line, which is disposed on the housing top of the atmosphere regulator for coating, comprising: a plurality of parallel base boards (22) with slot (30) formed therebetween, said slot is configured to have length corresponding to width of a sheet glass and communicated with alternately arranged entrance chamber and exhausting chamber thereover, an exit of the entrance chamber (26) and an entrance of the exhausting chamber (25) adapted to the slot formed between the base board having cooling cavity (21) filled with heat transfer oil as cooling media there over, graphite block (23) with round side in structure is disposed under the base board, entrance lane and exhausting lane with the width of the slot are formed between said adjacent graphite block, the air entrance of the entrance chamber communicate with air entrance distributor (19) which connects to the air entrance duct (20), the air exit of the exhausting chamber communicate with air exhaustion collector (17) which connects to the air exhausting duct (18).

9. A coating apparatus on float glass production line as claimed in claim 8, wherein the entrance chamber of the coating apparatus is cone-shape in structure having air distributor (24) disposed at the air exit to uniformly distribute the airflow, and air damper (27) disposed inside thereof.

10. A coating apparatus on float glass production line as claimed in claim 8, wherein the air damper (29) and negative pressure regulator (28) are disposed inside the exhausting chamber and the air damper is at the end of the air entrance.

11. A coating apparatus on float glass production line as claimed in claim 8, wherein the width of the slot in coating apparatus which is communicated with the exhausting chamber is wider than that which is communicated with the entrance chamber.

12. A coating apparatus on float glass production line as claimed in claim 8, wherein 2 to 8 entrance chambers and 3 to 9 exhausting chambers are disposed in the coating apparatus, the exhausting chamber is one more than the entrance chamber, and adjacent entrance chamber and exhausting chamber are of the same spacing therebetween.
